(19) United States
(12) Patent Application Publication
(10) Pub. No.: US 2018/0143546 A1
(43) Pub. Date: May 24, 2018

(54) METHOD FOR PRODUCING CURABLE LIQUID DEVELOPER

(71) Applicant: CANON KABUSHIKI KAISHA, Tokyo (JP)

(72) Inventors: Waka Hasegawa, Tokyo (JP); Ryo Natori, Tokyo (JP); Ayano Mashida, Kawasaki-shi (JP); Junji Ito, Hiratsuka-shi (JP); Yasuhiro Aichi, Tokyo (JP); Jun Shirakawa, Kawaguchi-shi (JP)

(21) Appl. No.: 15/814,834

(22) Filed: Nov. 16, 2017

(30) Foreign Application Priority Data
Nov. 24, 2016 (JP) 2016-228260
Oct. 10, 2017 (JP) 2017-196694

(51) Int. Cl. G03G 9/08; G03G 9/13

(52) U.S. Cl. CPC G03G 9/0804; G03G 9/132

(57) ABSTRACT

A method for producing a curable liquid developer including a toner particle including a colorant and a binder resin, a dispersant, and an insulating liquid (a) which does not dissolve the binder resin, the method including a step (1) of preparing a liquid mixture including the colorant, the binder resin, the insulating liquid (a), a solvent (b) which dissolves the binder resin, and the dispersant which is soluble in both the insulating liquid (a) and the solvent (b), and a step (2) of distilling off the solvent (b), wherein the insulating liquid (a) includes a monomer having a polymerizable functional group, and a molar average number of functional groups, a molar average SP value and an average molecular weight of the insulating liquid (a) are in specific range.

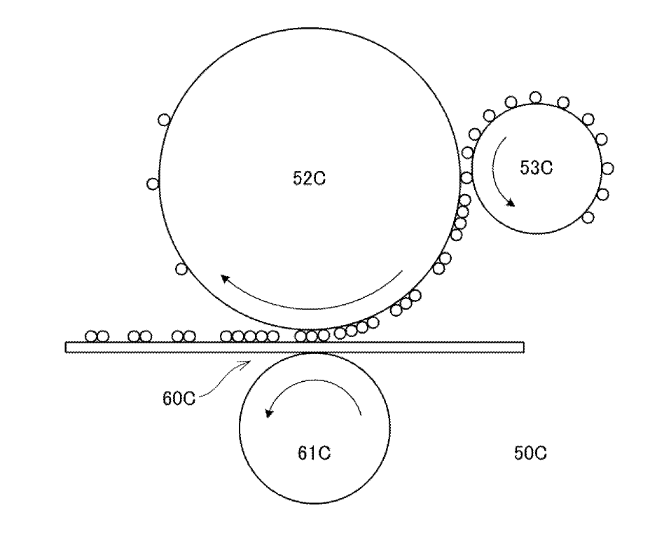

### BACKGROUND OF THE INVENTION

### Field of the Invention

The present invention relates to a method for producing a curable liquid developer used for an image forming apparatus making use of an electrophotographic process such as an electrophotographic method, an electrostatic recording method, or electrostatic printing.

### Description of the Related Art

In recent years, the need for a transition to color image forming apparatuses such as copying machines, facsimile machines, and printers that utilize the electrophotographic process has been growing. Among them, the development of high-image-quality and high-speed digital printing apparatuses utilizing an electrophotographic technique using a liquid developer has been advanced, such a technique excelling in reproducibility of fine line images, gradation reproducibility, color reproducibility and also ensuring excellent image formation at a high speed. Under such circumstances, liquid developers having better characteristics need to be developed.

Conventionally, a liquid developer in which colored resin particles are dispersed in an insulating liquid such as a hydrocarbon organic solvent or a silicone oil is known. However, where the insulating liquid of such a liquid developer remains on a recording medium such as paper or plastic film, image quality is greatly deteriorated. Therefore, it is necessary to remove the electrically insulating liquid. In order to remove the electrically insulating liquid, a method of applying heat energy to volatilize and remove the insulating liquid is generally used. However, such a method is not necessarily preferable from an environmental viewpoint because volatile organic solvent vapor is dissipated outside the apparatus and a large amount of energy is consumed.

To resolve this problem, Japanese Patent No. 4,977,034 discloses a method of curing an insulating liquid having a reactive functional group. This method using a monomer or oligomer having a reactive functional group as a curable insulating liquid makes it possible to form an image by consuming less energy than a thermal fixing method which requires to volatilize and remove an insulating liquid by applying thermal energy. A method based on a wet grinding method is disclosed as a method for producing such a curable liquid developer.

Meanwhile, Japanese Patent No. 4,022,078 discloses a technique developed to obtain a liquid developer which excels in dispersion stability, development characteristic and fixability and in which resin particles including a pigment or the like and dispersed in a highly insulating solvent have a small particle diameter and a narrow particle size distribution. In this technique, a coacervation method is used, a solvent dissolving a resin is distilled off at a temperature lower than the softening point of the resin, while stirring with a high-speed shear stirring device, and the resin is precipitated on the surface of the pigment.

### SUMMARY OF THE INVENTION

A problem associated with the technique described in Japanese Patent No. 4,977,034 is that the wet grinding treatment has to be carried out for a long time in order to obtain the desired particle diameter, the production requires a long time, and the production efficiency is greatly reduced. In addition, the curing speed at the time of image formation is not sufficient.

Further, in order to obtain a high-quality image with a thin film, it is required that the toner particle diameter be small and the particle size distribution be sharp. However, the toner in the liquid developer disclosed in Japanese Patent No. 4,022,078 has a large particle diameter, which is not sufficient for obtaining a high-quality image with a thin film.

The present invention provides a method for producing a curable liquid developer having a small particle diameter of a toner particle and a satisfactory curing rate during image formation.

The present invention provides a method for producing a curable liquid developer including a toner particle including a colorant and a binder resin, a dispersant, and an insulating liquid (a) which does not dissolve the binder resin, the method comprising:

a step (1) of preparing a liquid mixture including the colorant, the binder resin, the insulating liquid (a) which does not dissolve the binder resin, a solvent (b) which dissolves the binder resin, and the dispersant which is soluble in both the insulating liquid (a) and the solvent (b); and

a step (2) of distilling off the solvent (b) from the liquid mixture, wherein

the insulating liquid (a) includes a monomer having a polymerizable functional group;

a molar average number of functional groups in the insulating liquid (a) is at least 1.8;

a molar average SP value of the insulating liquid (a) is not more than 9.0; and

an average molecular weight of the insulating liquid (a) is at least 250.

According to the present invention, it is possible to provide a method for producing a curable liquid developer having a small particle diameter of a toner particle and a satisfactory curing rate during image formation.

Further features of the present invention will become apparent from the following description of exemplary embodiments with reference to the attached drawings.

### BRIEF DESCRIPTION OF THE DRAWINGS

The FIGURE is a schematic view of a developing device used in Examples.

### DESCRIPTION OF THE EMBODIMENTS

The present invention provides a method for producing a curable liquid developer including a toner particle including a colorant and a binder resin, a dispersant, and an insulating liquid (a) which does not dissolve the binder resin, the method comprising:

a step (1) of preparing a liquid mixture including the colorant, the binder resin, the insulating liquid (a) which does not dissolve the binder resin, a solvent (b) which dissolves the binder resin, and the dispersant which is soluble in both the insulating liquid (a) and the solvent (b); and

a step (2) of distilling off the solvent (b) from the liquid mixture, wherein

the insulating liquid (a) includes a monomer having a polymerizable functional group;

a molar average number of functional groups in the insulating liquid (a) is at least 1.8;

a molar average SP value of the insulating liquid (a) is not more than 9.0; and

an average molecular weight of the insulating liquid (a) is at least 250.

In the present invention, the expressions “at least AA and not more than BB” and “AA to BB” representing the numerical range mean, unless otherwise specified, a numerical range including a lower limit and an upper limit which are endpoints.

Each material will be described in detail below.

Binder Resin

The toner particle includes a binder resin. A known binder resin having fixability to an adherend such as paper or plastic film can be used as the binder resin.

The binder resin is not particularly limited as long as it is soluble in the solvent (b) and is not soluble in the insulating liquid (a).

The amount of the binder resin dissolving in 100 parts by mass of the insulating liquid (a) at a temperature of 25° C. being not more than 1 part by mass can be used as an indicator that “the binder resin is not soluble in the insulating liquid (a)”.

The amount of the binder resin dissolving in 100 parts by mass of the solvent (b) at a temperature of 25° C. being more than 10 parts by mass can be used as an indicator that “the binder resin is soluble in the solvent (b)”.

Examples of the binder resin include an epoxy resin; a polyester-based resin such as an alkyd resins and a polyester resin; a vinyl resin such as a polyethylene resin, a (meth)acrylic resin, an ethylene-(meth)acrylic resin, and a Styrene-(meth)acrylic resin; and a rosin-modified resin; a polyurethane resin; a polyamide resin; a polyimide resin; a silicon resin; and a phenolic resin. These resins may be used in combination of two or more thereof.

It is preferable to use at least one binder resin selected from the group consisting of a vinyl resin, a polyester resin, a polyurethane resin, and an epoxy resin, and it is more preferable to use at least one binder resin selected from the group consisting of a polyester resin and a vinyl resin.

Further, it is preferable that the binder resin include a polyester resin and the amount of the polyester resin in the binder resin be at least 50% by mass, more preferably at least 60% by mass, and even more preferably at least 80% by mass. Meanwhile, the upper limit is preferably not more than 100% by mass.

The polyester resin is preferably a polycondensate of a diol and a dicarboxylic acid. A tricarboxylic acid may also be used. A polycondensate of a diol, a dicarboxylic acid and a tricarboxylic acid is more preferred.

Examples of the diol include ethylene glycol, propylene glycol, neopentyl glycol, an ethylene oxide adduct and/or a propylene oxide adduct of bisphenol A and the like.

Examples of the dicarboxylic acid include terephthalic acid, isophthalic acid, orthophthalic acid, fumaric acid and the like.

Examples of the tricarboxylic acid include trimesic acid, trimellitic acid and the like.

Examples of monomers suitable for a vinyl resin include styrene, (meth)acrylic acid, methyl (meth)acrylate, butyl (meth)acrylate and the like.

An acid value of the binder resin is preferably at least 5 mg KOH/g and not more than 100 mg KOH/g. When the acid value of the binder resin is at least 5 mg KOH/g, the resin can sufficiently interact with the dispersant, whereby the particle diameter of the toner particle in the liquid developer can be sufficiently reduced.

Colorant

The colorant included in the toner particle is not particularly limited, and known organic pigments, organic dyes, inorganic pigments, or pigments can be used. These pigments and the like can be dispersed in an insoluble resin or the like as a dispersion medium, or a resin can be grafted onto the pigment surface.

Specific examples of the pigments are presented below. Thus, yellow pigments can be exemplified by the following pigments.

C. I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, 185; C. I. Vat Yellow 1, 3, 20.

Examples of red or magenta pigments are presented below.

C. I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269; C. I. Pigment Violet 19; C. I. Vat Red 1, 2, 10, 13, 15, 23, 29, 35.

Examples of blue or cyan color pigments are presented below.

C. I. Pigment Blue 2, 3, 15:2, 15:3, 15:4, 16, 17; C. I. Vat Blue 6; C. I. Acid Blue 45, and copper phthalocyanine pigments in which 1 to 5 phthalimidomethyl groups are substituted into a phthalocyanine skeleton.

Examples of green pigments are presented below.

C. I. Pigment Green 7, 8, 36.

Examples of orange pigments are presented below.

C. I. Pigment Orange 66, 51.

Examples of black pigments are presented below.

Carbon black, titanium black, and aniline black.

Examples of white pigments are presented below.

Basic lead carbonate, zinc oxide, titanium oxide, and strontium titanate.

For dispersing the pigment in the toner particles, dispersing means corresponding to the toner particle production method may be used. Examples of devices suitable as the dispersing means include a ball mill, a sand mill, an attritor, a roll mill, a jet mill, a homogenizer, a paint shaker, a kneader, an agitator, a Henschel mixer, a colloid mill, an ultrasonic homogenizer, a pearl mill, a wet jet mill and the like.

It is also possible to add a pigment dispersant when dispersing the pigment. Examples of the pigment dispersant include hydroxyl group-containing carboxylic acid esters, salts of long-chain polyaminoamides and high-molecular-weight acid esters, salts of high-molecular-weight polycarboxylic acids, high-molecular-weight unsaturated acid esters, high-molecular-weight copolymers, modified polyacrylates, aliphatic polyvalent carboxylic acids, naphthalenesulfonic acid formalin condensates, polyoxyethylene alkyl phosphoric acid esters, pigment derivatives and the like. It is also preferable to use a commercially available polymer dispersant such as Solsperse series manufactured by The Lubrizol Corporation.

Further, the pigment dispersant is more preferably a polymer obtained by a reaction between a diisocyanate compound and a polyester polyol having an alkali metal base or alkaline earth metal base of a sulfonic acid. Examples of such resins include VYLON UR series (manufactured by Toyobo Co., Ltd.) and the like.

A synergist corresponding to each pigment can also be used as a pigment dispersion aid.

These pigment dispersants and pigment dispersion aids are preferably added at 1 part by mass to 50 parts by mass with respect to 100 parts by mass of the pigment.

Insulating Liquid (a)

The curable liquid developer includes an insulating liquid (a) that does not dissolve the binder resin.

The insulating liquid refers to an electrically insulating material, and preferably has a volume resistivity of at least 1×10⁹ Ω·cm and not more than 1×10¹³ Ω·cm.

Number of Polymerizable Functional Groups in Insulating Liquid (a)

The insulating liquid (a) includes a monomer having a polymerizable functional group.

The molar average number of functional groups in the insulating liquid (a) is at least 1.8. When the molar average number of functional groups in the insulating liquid (a) is less than 1.8, sufficient curability cannot be obtained. Meanwhile, the upper limit is not particularly limited, but is preferably not more than 5.0, and more preferably not more than 3.0.

For example, when the insulating liquid (a) is composed of Awt parts by mass of a compound A in which the number of polymerizable functional groups is An and the molecular weight is Amw, and Bwt parts by mass of a compound B in which the number of polymerizable functional groups is Bn and the molecular weight is Bmw, the molar average number of functional groups in the insulating liquid (a) is obtained in the following manner. When a polymer or an oligomer such as a hydrophobic polymer described hereinbelow is used for the insulating liquid (a), the weight average molecular weight thereof may be used as the molecular weight.

$$Molar average number of functional groups = \frac{An \times Awt / Amw + Bn \times Bwt / Bmw}{Awt / Amw + Bwt / Bmw}$$

SP Value of Insulating Liquid (a)

The molar average SP value of the insulating liquid (a) is not more than 9.0. When the molar average SP value of the insulating liquid (a) is higher than 9.0, it becomes difficult to obtain a toner particle of a sufficiently small diameter. Meanwhile, the lower limit is not particularly limited, but is preferably at least 6.5, and more preferably at least 7.0.

When the insulating liquid (a) is composed of Awt parts by mass of a compound A with the SP value Asp and the molecular weight Amw, and Bwt parts by mass of a compound B with the SP value Bsp and the molecular weight Bmw, the molar average SP value of the insulating liquid (a) is obtained in the following manner. When a polymer or an oligomer such as a hydrophobic polymer described hereinbelow is used for the insulating liquid (a), the weight average molecular weight thereof may be used as the molecular weight.

$$Molar average SP value = \frac{Asp \times Awt / Amw + Bsp \times Bwt / Bmw}{Awt / Amw + Bwt / Bmw}$$

The same method for finding the aforementioned number and value is used even when three or more kinds of compounds are mixed and used.

The SP value is a solubility parameter. The SP value is a value introduced by Hildebrand and defined by the regular theory. This value is represented by the square root of the cohesive energy density of the solvent (or solute) and serves as a measure of solubility of a two-component solution. The SP value in the present invention is found by calculations from the evaporation energy and molar volume of atoms and atomic groups suggested by Fedors and described in the Fundamentals and Engineering of Coating (page 53, Yuji Harasaki, Converting Technical Institute). The unit of the SP value in the present invention is (cal/cm³)^{1/2}, but it can be converted into a unit of (J/m³)^{1/2} by using the relationship of 1 (cal/cm³)^{1/2}=2.046×10³ (J/m³)^{1/2}.

Molecular Weight of Insulating Liquid (a)

The average molecular weight of the insulating liquid (a) is at least 250. When the average molecular weight of the insulating liquid (a) is less than 250, it becomes difficult to obtain a toner particle of a sufficiently small diameter. Meanwhile, the upper limit is not particularly limited, but is preferably not more than 1000, and more preferably not more than 800.

For example, when the insulating liquid (a) is composed of Awt parts by mass of the compound A having the molecular weight Amw and Bwt parts by mass of the compound B having the molecular weight Bmw, the average molecular weight of the insulating liquid (a) is obtained in the following manner. When a polymer or an oligomer such as a hydrophobic polymer described hereinbelow is used for the insulating liquid (a), the weight average molecular weight thereof may be used as the molecular weight.

$$Average molecular weight = \frac{Awt \times Amw + Bwt \times Bmw}{Awt + Bwt}$$

Types of Insulating Liquid (a)

Generally, since a polymerizable functional group has a higher SP value than a hydrocarbon group, where the molar average number of polymerizable functional groups is increased in order to increase the curing rate at the time of image formation, the molar average SP value of the mixture tends to increase. However, in order to produce a curable liquid developer in which the particle diameter of the toner particle in the liquid developer is small by the coacervation method, it is preferable that the SP value of the insulating liquid (a) be low.

As a result of comprehensive research conducted by the inventors, it was found that when the molar average functional group number of the insulating liquid (a) is at least 1.8, the molar average SP value is not more than 9.0, and the average molecular weight is at least 250, it is possible to obtain a curable liquid developer having a small particle diameter of a toner particle in the curable liquid developer and a satisfactory curing rate during image formation. The present invention has been accomplished on the basis of this finding.

The insulating liquid (a) may include an insulating liquid other than the monomer having the abovementioned specific polymerizable functional group, as long as the effect of the present invention is not impaired. It is preferable that the insulating liquid (a) be composed of a monomer having a polymerizable functional group which satisfies the above-mentioned relationship.

For example, a hydrophobic polymer composed of a hydrocarbon chain or the like may be included in the insulating liquid (a) in addition to the monomer having a polymerizable functional group. As a result, it is possible to lower the molar average SP value and increase the average molecular weight, as compared with the insulating liquid composed only of a monomer having a polymerizable functional group. The hydrophobic polymer composed of a hydrocarbon chain and the like can be exemplified by a BI series (manufactured by Nippon Soda Co., Ltd.) and the like.

The amount of the monomer (polymerizable monomer) having a polymerizable functional group in the insulating liquid (a) is at least 60% by mass and not more than 100% by mass, and more preferably at least 90% by mass and not more than 100% by mass with respect to the total mass of the insulating liquid (a).

Examples of the monomer having a polymerizable functional group include acrylic monomers, cyclic ether monomers such as epoxy and oxetane, and vinyl ether.

When cationic polymerization is used for polymerizing the curable liquid developer, it is preferable that the insulating liquid (a) include at least one type of polymerizable monomer among the vinyl ethers represented by a general formula (1). That is, the monomer having a polymerizable functional group is preferably a compound represented by the general formula (1).

(R1-CH═CH—O—)ₙR2 Formula (1)

[In the formula (1), n represents an integer of at least 2, R1 represents a hydrogen atom or an alkyl group having at least 1 and not more than 3 carbon atoms, and R2 represents an n-valent group obtained by removing n hydrogen atoms from an aliphatic hydrocarbon.]

In the compound represented by the general formula (1), since the bias of the electron density in the molecule is small, a curable liquid developer with high resistance, low viscosity, and high sensitivity can be obtained.

Specific examples (Exemplary Compounds (1) to (10)) of the compound represented by the general formula (1) are listed below, but monomers having a polymerizable functional group are not limited to these examples.

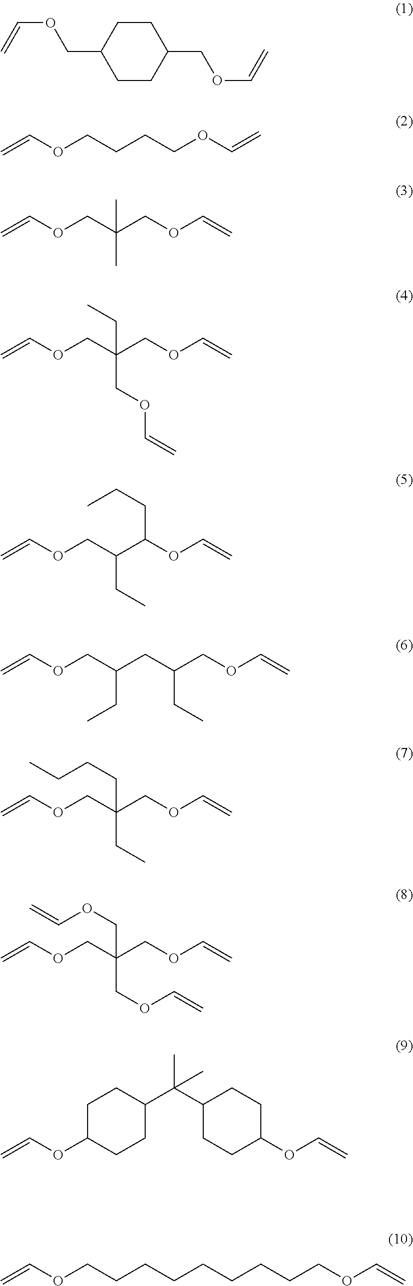

Further, it is more preferable that the monomer having a polymerizable functional group be a compound represented by a general formula (2).

(R1-CH═CH—O—)ₙCₘH₍₂ₘ₊₂₋ₙ₎ Formula (2)

[In the formula (2), m represents an integer of at least 12 and not more than 50, n represents an integer of at least 2, and R1 represents a hydrogen atom or an alkyl group having at least 1 and not more than 3 carbon atoms.]

In the general formula (2),

(R1-CH═CH—O—)ₙ Formula (2A)

[in the formula (2A), n and R1 have the same meanings as n and R1 in the formula (2)]
represents an embodiment of a vinyl ether group, and n represents the number of vinyl ether groups contained in one monomer molecule.

The vinyl ether compound of the formula (2) is a polyfunctional monomer having a plurality of vinyl ether groups since n is an integer of at least 2. By using a polyfunctional monomer, it is possible to obtain a curable liquid developer which is unlikely to be influenced by polymerization inhibition caused by moisture and has good fixability under humid environment.

Generally, the cationic polymerization reaction is a polymerization reaction in which an acid generated by decomposition from a polymerization initiator under heating or irradiation with light reacts with a monomer to produce a cation active species, and the polymerization reactions apparently sequentially advances as long as this cation active species is present.

When a vinyl ether compound is used, a cation active species is apparently produced by a reaction of the acid generated from the polymerization initiator with the vinyl ether structure. At this time, where a water molecule is present in the vicinity of the monomer, this cation active species is trapped, so that further polymerization does not proceed.

Thus, the chain reaction of one vinyl ether structure is stopped per one molecule of water. It follows from the above that a larger number n is advantageous for fixing the curable liquid developer.

Meanwhile, where the number n increases, it becomes difficult to procure a monomer having a corresponding polymerizable functional group.

In consideration of these, n in the general formulas (2) and (2A) is preferably at least 2 and not more than 6, more preferably at least 2 and not more than 4, and even more preferably 2 or 3.

Meanwhile, in the general formula (2),

CₘH₍₂ₘ₊₂₋ₙ₎ Formula (2B)

[in the formula (2B), m and n have the same meanings as m and n in the formula (2)]
is an alkane chain, and m is the carbon number of the alkane chain. Hydrocarbons may be branched in the middle, and by setting the carbon number of the alkane chain to at least 12, volatilization of the monomers can be substantially prevented, and where the carbon number is at least 18, volatilization of the monomer can be completely prevented.

Meanwhile, as for the upper limit of the carbon number of the alkane chain, attention needs to be paid to viscosity. In order to maintain the electrophoretic speed of the toner particle, the viscosity of the curable liquid developer is preferably at least 0.5 mPa·s and not more than 100 mPa·s, and more preferably at least 0.5 mPa·s and not more than 30 mPa·s at 25° C.

When the viscosity is within the above range, the electrophoretic speed of the toner particle becomes appropriate, and the printing speed and the printing density are favorable.

Meanwhile, with respect to the carbon number of the alkane chain in the general formulas (2) and (2B), the viscosity of the monomer itself tends to increase as the carbon number increases. In consideration of these, the carbon number (that is, the value of m) of the alkane chain in the general formulas (2) and (2B) is preferably not more than 50, and more preferably not more than 25.

From the viewpoint of the SP value, where a methyl group is present at the end of the alkane chain, the SP value tends to decrease. Therefore, where a methyl group remains at the end of the alkane chain, curing inhibition by moisture is less likely to occur, which is advantageous in terms of fixability.

That is, from the viewpoint of fixability, it is more preferable that at least one of the vinyl ether groups represented by the general formula (2A) in the general formula (2) be bonded to a carbon atom other than the end atom among the carbon atoms constituting the partial structure represented by the general formula (2B) in the general formula (2).

Specific examples (Exemplary Compounds (11) to (39)) of the compound represented by the general formula (2) are listed below, but the invention is not limited to these examples.

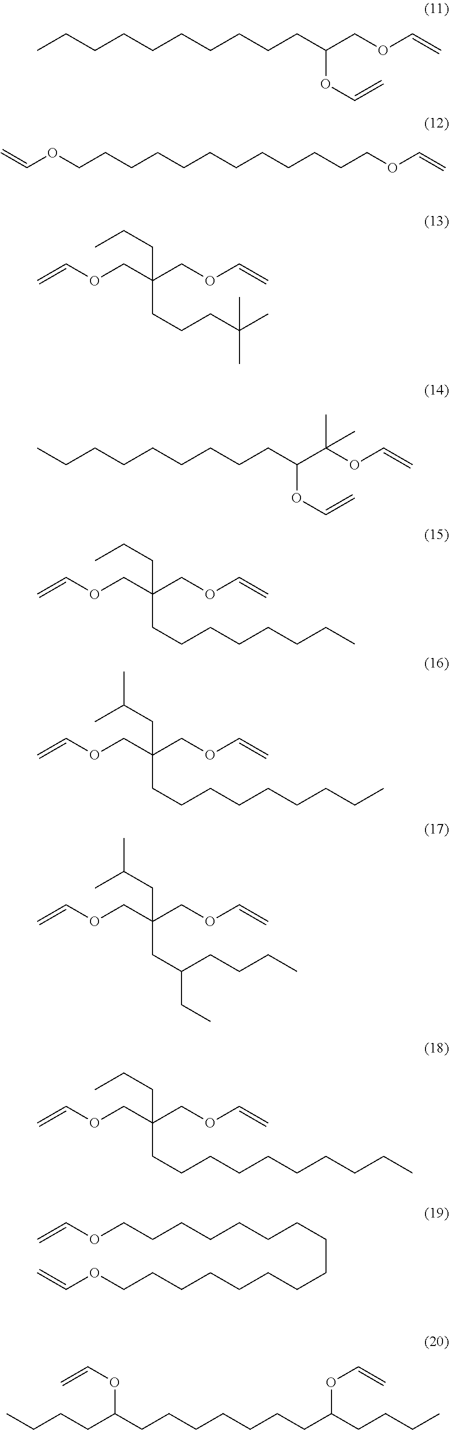

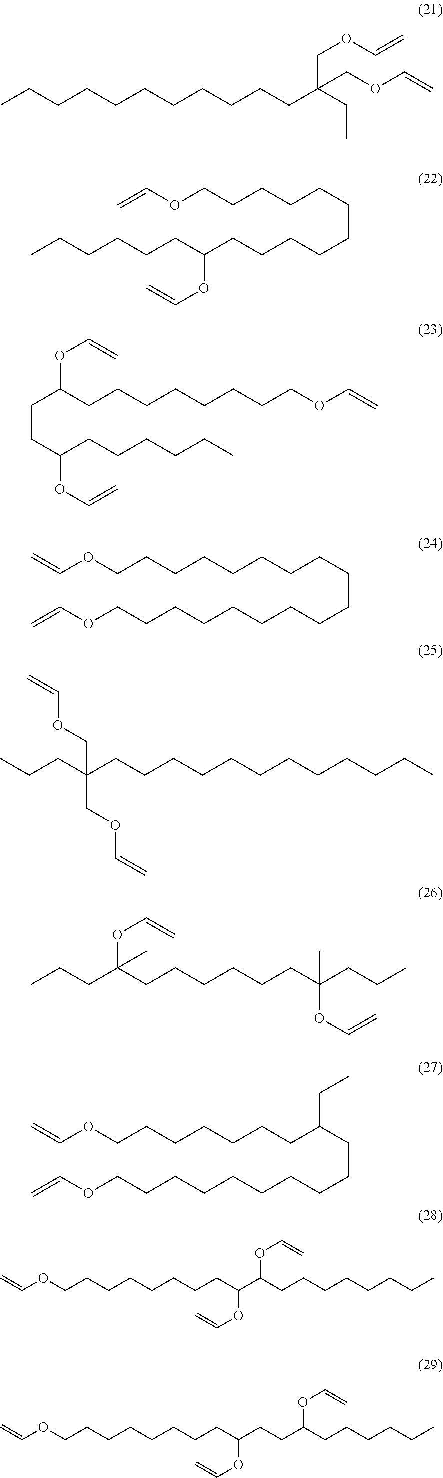

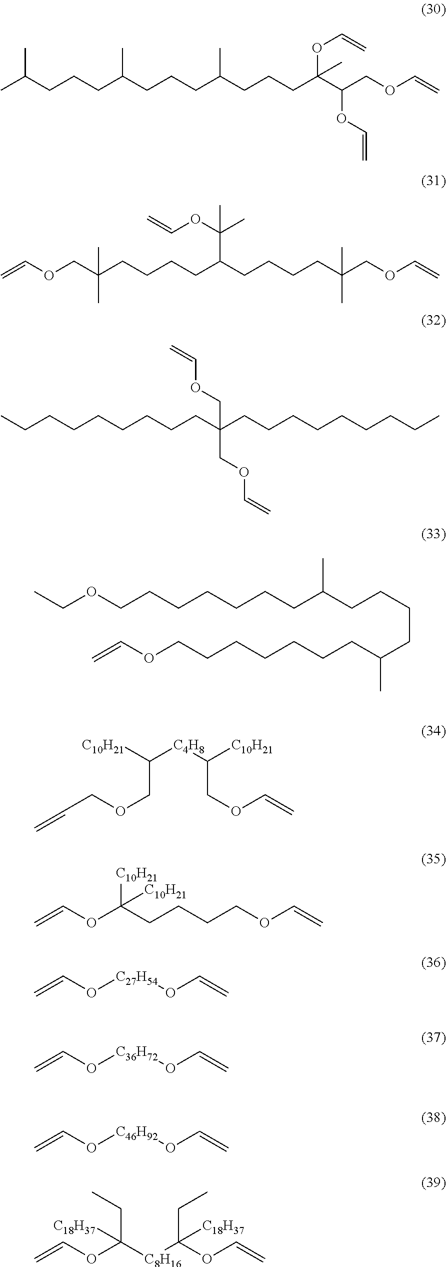

The compounds represented by the general formulas (1) and (2) can be synthesized by substituting hydrogen atoms of the alkane with a plurality of hydroxyl groups, and vinyl-etherification of the hydroxyl groups.

From the viewpoint of availability, it is preferable that the alkane as a raw material have not more than 25 carbon atoms. Compounds having 12 or 18 carbon atoms can be particularly advantageously used since they can be obtained from natural products such as castor oil.

There are also commercially available hydroxylated alkanes, and 1,2-dodecanediol (manufactured by Tokyo Chemical Industry Co., Ltd.), 1,12-dodecanediol (manufactured by Tokyo Chemical Industry Co., Ltd.), 1,12-octadecanediol (trade name HSTOL, manufactured by Kokura Synthetic Industries, Ltd), phytantriol (manufactured by Kuraray Co., Ltd.) and the like can be procured.

In the case of using cationic polymerization for polymerization of the curable liquid developer, the insulating liquid (a) may include, in addition to the compounds represented by the general formulas (1) and (2), various monomers having polymerizable functional groups for the purpose of viscosity modification and the like.

These monomers having polymerizable functional groups are not particularly limited as long as they do not impair the developing performance and fixability of the curable liquid developer, and they can be exemplified by acrylic monomers, cyclic ether monomers such as epoxide and oxetane, and vinyl ether compounds other than the compounds represented by the general formulas (1) and (2).

Among them, vinyl ether compounds other than the compounds represented by the general formulas (1) and (2), which make it possible to obtain a curable liquid developer having high volume resistivity, low viscosity, and high sensitivity are preferred.

Specific examples (Exemplary Compounds (101) to (111)) of vinyl ether compounds other than the compounds represented by the general formulas (1) and (2) are listed below, but the present invention is not limited to these examples.

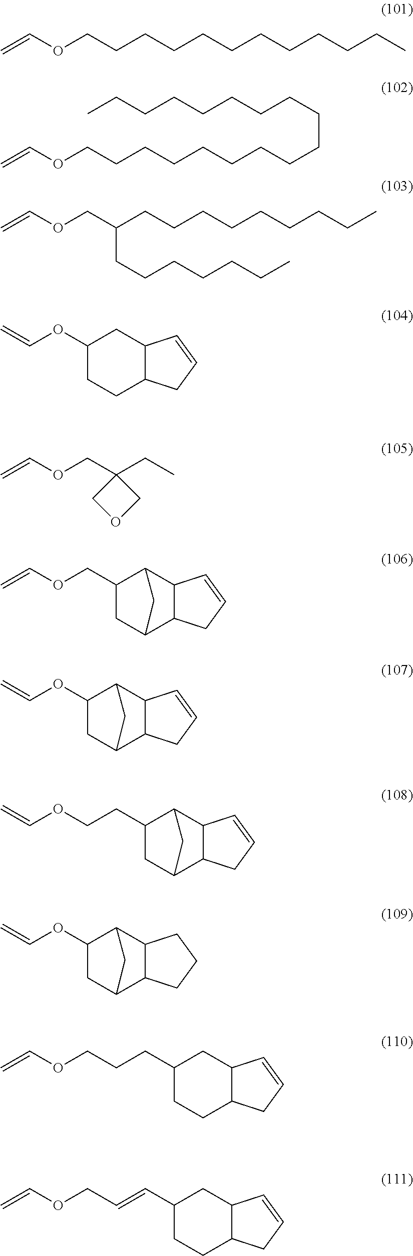

Solvent (b)

The binder resin is soluble in the solvent (b).

The SP value of the solvent (b) is preferably higher than the SP value of the insulating liquid (a). Further, the SP value of the solvent (b) is preferably at least 8.5 and not more than 15.0, and more preferably at least 9.0 and not more than 13.0. The binder resin is preferably a resin soluble in a solvent (b) having an SP value of at least 8.5 and not more than 15.0.

Further, since the solvent (b) is distilled off from the mixture by, for example, distillation or the like, it is preferable that the solvent have a low boiling point. The boiling point of the solvent (b) is preferably not more than 150° C., and more preferably not more than 100° C.

Examples of the solvent (b) include toluene (SP value 8.9, boiling point 110° C.), chloroform (SP value 9.2, boiling point 61° C.), methyl ethyl ketone (SP value 9.3, boiling point 80° C.), tetrahydrofuran (SP value 9.5, boiling point 66° C.), acetone (SP value 9.8, boiling point 56° C.), ethanol (SP value 13, boiling point 78° C.), and methanol (SP value 14, boiling point 65° C.)

Dispersant

The curable liquid developer contains a dispersant. The dispersant promotes the formation of toner particles and stably disperses the toner particles in the insulating liquid (a).

In addition, the dispersant is soluble in both the insulating liquid (a) and the solvent (b).

The amount of the dispersant dissolving in 100 parts by mass of the insulating liquid (a) at a temperature of 25° C. being more than 10 parts by mass and the amount of the dispersant dissolving in 100 parts by mass of the solvent (b) at a temperature of 25° C. being more than 10 parts by mass can be used as an indicator that “the dispersant is soluble in the insulating liquid (a) and the solvent (b)”.

The coacervation method is a method for producing toner particles by utilizing a phenomenon that a polymer dissolved in a good solvent undergoes phase separation when a poor solvent is added.

In the case of producing a liquid developer by using the coacervation method, the dispersion stability of the toner particles in the insulating liquid (a) can be improved by dispersing the toner particles in the insulating liquid (a) in the presence of a dispersant. Further, the charging property and electrophoretic property of the toner particles can thus be also improved.

Such a dispersant is not particularly limited as long as it is soluble in the insulating liquid (a) and the solvent (b) and stably disperses the toner particles, and the dispersant can be selected from among known dispersants.

Examples of the commercial dispersants include AJISPER PB 817 (reaction product of polyallylamine and a self-condensate of 12-hydroxystearic acid; product of Ajinomoto Fine-Techno Co., Inc.), Solsperse 13940 (a reaction product of polyethylene polyamine and a self-condensate of 12-hydroxystearic acid), 11200, 17000, 18000 (manufactured by Lubrizol Japan Limited) and the like.

Further, as the dispersant, a dispersant having a monomer unit having a primary amino group at a position other than the end position is more preferable. AJISPER PB 817 and the like are such dispersants. Meanwhile, in Solsperse 13940 (amino groups are obtained from a reaction product of polyethylene polyamine and a self-condensate of 12-hydroxystearic acid) all amino groups other than the end amino groups are secondary amino groups or tertiary amino groups. That is, the dispersant has no primary amino group other than the end amino group.

The amount of the dispersant is preferably at least 0.5 parts by mass and not more than 20 parts by mass with respect to 100 parts by mass of the binder resin.

Within this range, the dispersibility of the toner particles is improved, and the fixing strength of the toner particles can be satisfactorily maintained without the dispersant capturing the insulating liquid (a). The dispersants can be used singly or in combination of two or more thereof.

Charge Control Agent

The curable liquid developer may optionally include a charge control agent. As the charge control agent, known charge control agents can be used. Specific examples thereof are presented below.

Oils and fats such as linseed oil and soybean oil; alkyd resins, halogen polymers, aromatic polycarboxylic acids, water-soluble dyes containing acidic groups, oxidized condensation products of aromatic polyamines, metal soaps such as cobalt naphthenate, nickel naphthenate, iron naphthenate, zinc naphthenate, cobalt octylate, nickel octylate, zinc octylate, cobalt dodecylate, nickel dodecylate, zinc dodecylate, aluminum stearate, and cobalt 2-ethylhexanoate; metal salts of sulfonic acids such as metal salts of petroleum-based sulfonic acids and metal salts of sulfosuccinic acid esters; phospholipids such as hydrogenated lecithin and lecithin; salicylic acid metal salts such as t-butylsalicylic acid metal complexes; polyvinylpyrrolidone resin, polyamide resin, sulfonic acid-containing resin, hydroxybenzoic acid derivatives and the like.

Charge Adjuvant

A toner particle may include a charge adjuvant for the purpose of adjusting the charging performance of the toner particle. As the charge adjuvant, known ones can be used.

Examples of specific compound include metal soaps such as zirconium naphthenate, cobalt naphthenate, nickel naphthenate, iron naphthenate, zinc naphthenate, cobalt octylate, nickel octylate, zinc octylate, cobalt dodecylate, nickel dodecylate, zinc dodecylate, aluminum stearate, aluminum tristearate and cobalt 2-ethylhexanoate; metal salts of sulfonic acids such as metal salts of petroleum-based sulfonic acids and metal salts of sulfosuccinic acid esters; phospholipids such as lecithin; salicylic acid metal salts such as t-butylsalicylic acid metal complexes; polyvinylpyrrolidone resin, polyamide resin, sulfonic acid-containing resin, hydroxybenzoic acid derivatives and the like.

Polymerization Initiator

The curable liquid developer may optionally include a polymerization initiator. When the curable liquid developer is obtained by cationic polymerization, the polymerization initiator is preferably represented by a following general formula (3).

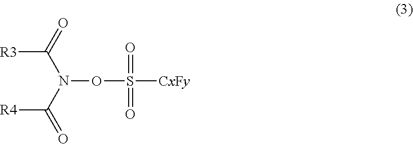

[In Formula (3), R3 and R4 are bonded to each other to form a ring structure, x represents an integer of 1 to 8, and y represents an integer of 3 to 17.]

The polymerization initiator represented by the general formula (3) is photo-decomposed by irradiation with ultraviolet light to generate a sulfonic acid which is a strong acid. It is also possible to decompose the initiator and generate a sulfonic acid by additionally using a sensitizer, with the absorption of ultraviolet rays by the sensitizer serving as a trigger.

Examples of the ring structure formed by bonding R3 and R4 include a 5-membered ring and a 6-membered ring. Specific examples of the ring structure formed by bonding R3 and R4 include a succinimide structure, a phthalimide structure, a norbornene dicarboximide structure, a naphthalene dicarboximide structure, a cyclohexane dicarboximide structure, an epoxy cyclohexene dicarboximide structure and the like.

The ring structure may also have, as a substituent, an alkyl group having 1 to 18 carbon atoms, an alkyloxy group having 1 to 18 carbon atoms, an alkylthio group having 1 to 18 carbon atoms, an aryl group having 1 to 14 carbon atoms, an aryloxy group having 1 to 14 carbon atoms, an arylthio group having 1 to 14 carbon atoms, or the like. Further, other ring structures such as alicyclic ring, heterocyclic ring and aromatic ring which may have a substituent may be condensed.

The CxFy in the general formula (3) can be exemplified by a linear alkyl group (RF1) in which a hydrogen atom is substituted with a fluorine atom, a branched alkyl group (RF2) in which a hydrogen atom is substituted with a fluorine atom, a cycloalkyl group (RF3) in which a hydrogen atom is substituted with a fluorine atom, and an aryl group (RF4) in which a hydrogen atom is substituted with a fluorine atom.

Examples of the linear alkyl group (RF1) in which a hydrogen atom is substituted with a fluorine atom include a trifluoromethyl group (x=1, y=3), a pentafluoroethyl group (x=2, y=5), a hepta fluoro n-propyl group (x=3, y=7), a nonafluoro n-butyl group (x=4, y=9), a perfluoro n-hexyl group (x=6, y=13), a perfluoro n-octyl group (x=8, y=17) and the like.

Examples of the branched alkyl group (RF2) in which a hydrogen atom is substituted with a fluorine atom include a perfluoroisopropyl group (x=3, y=7), a perfluoro-tert-butyl group (x=4, y=9), a perfluoro-2-ethylhexyl group (x=8, y=17) and the like.

Examples of the cycloalkyl group (RF3) in which a hydrogen atom is substituted with a fluorine atom include a perfluorocyclobutyl group (x=4, y=7), a perfluorocyclopentyl group (x=5, y=9), a perfluorocyclohexyl group (x=6, y=11), a perfluoro(1-cyclohexyl) methyl group (x=7, y=13) and the like.

Examples of the aryl group (RF4) in which a hydrogen atom is substituted with a fluorine atom include a pentafluorophenyl group (x=6, y=5), a 3-trifluoromethyltetrafluorophenyl group (x=7, y=7) and the like.

Among the CxFy in the general formula (3), from the viewpoints of availability and decomposability of the sulfonic acid ester moiety, a linear alkyl group (RF1), a branched chain alkyl group (RF2), and an aryl group (RF4) are preferred. A linear alkyl group (RF1) and an aryl group (RF4) are more preferred. Particularly preferred are a trifluoromethyl group (x=1, y=3), a pentafluoroethyl group (x=2, y=5), a heptafluoro n-propyl group (x=3, y=7), a nonafluoro n-butyl group (x=4, y=9), and a pentafluorophenyl group (x=6, y=5).

The photopolymerization initiators may be used singly or in combination of two or more thereof.

The amount of the photopolymerization initiator in the curable liquid developer is not particularly limited, but it is preferably 0.01 part by mass to 5 parts by mass, more preferably 0.05 part by mass to 1 part by mass, and more preferably 0.1 parts by mass to 0.5 parts by mass with respect to 100 parts by mass of the monomer having a polymerizable functional group.

Specific examples (Exemplary Compounds A-1 to A-27) of the photopolymerization initiator represented by the general formula (3) are listed below, but the invention is not limited to these examples.

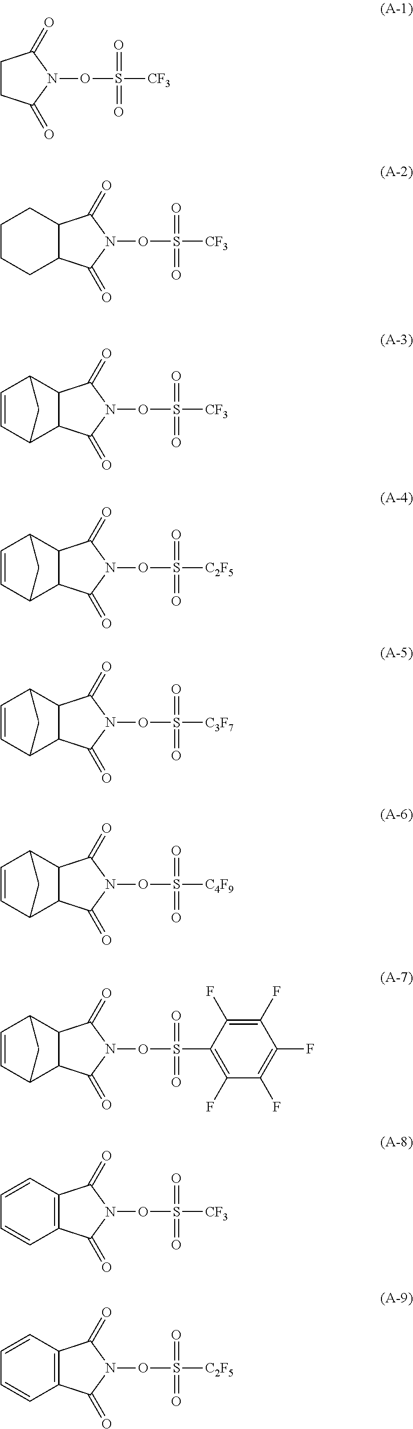

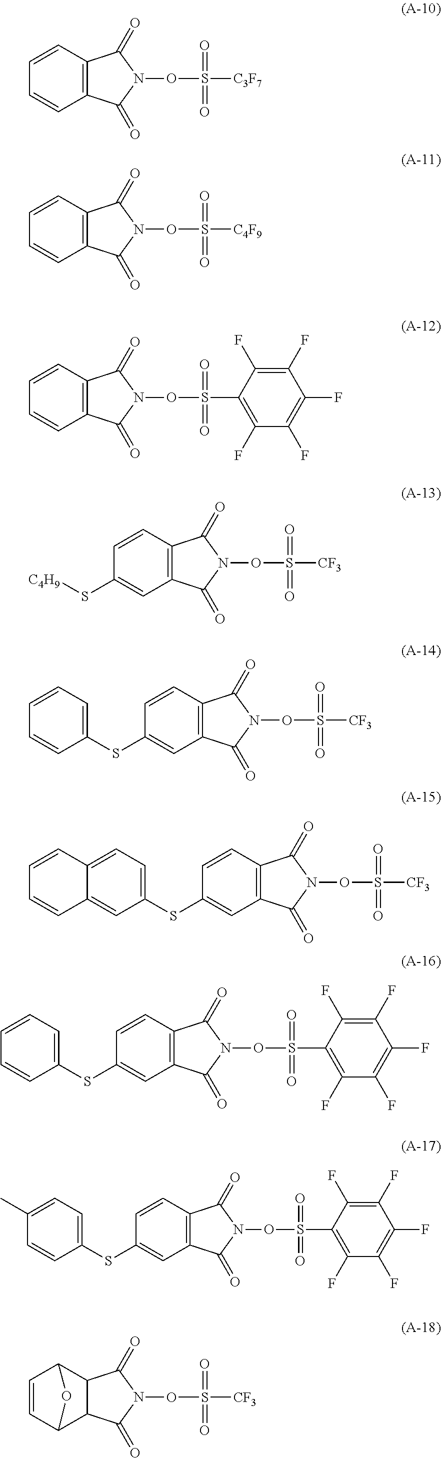

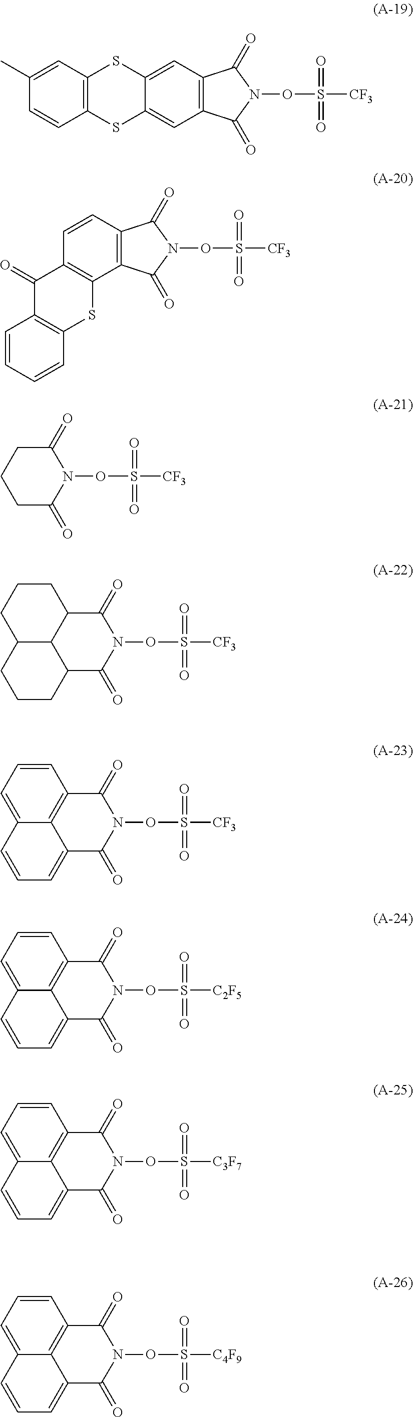

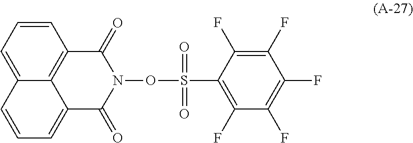

Among them, (A-23), (A-24), (A-25), (A-26), and (A-27) are particularly preferred because high fixability is easily achieved when the initiator is used in combination with a sensitizer.

Sensitizer

Where the curable liquid developer is photocurable, a sensitizer may be added, if necessary, for the purpose of improving the acid generation efficiency of the polymerization initiator and increasing the wavelength of the photosensitive wavelength.

The sensitizer is not particularly limited as long as it sensitizes the polymerization initiator with an electron transfer mechanism or an energy transfer mechanism.

Specific examples of the sensitizer include aromatic polycondensed compounds such as anthracene, 9,10-dialkoxyanthracene, pyrene, and perylene; aromatic ketone compounds such as acetophenone, benzophenone, thioxanthone, and Michler's ketone; and hetero ring compounds such as phenothiazine and N-aryloxazolidinone.

The amount of the sensitizer is appropriately selected according to the purpose, but is preferably at least 0.1 parts by mass and not more than 10 parts by mass, and more preferably at least 1 part by mass and not more than 5 parts by mass with respect to 1 part by mass of the polymerization initiator.

A sensitizing aid may be added to the curable liquid developer for the purpose of further improving the electron transfer efficiency or energy transfer efficiency between the sensitizer and the polymerization initiator.

Specific examples of the sensitizing aid include naphthalene compounds such as 1,4-dihydroxynaphthalene, 1,4-dimethoxynaphthalene, 1,4-diethoxynaphthalene, 4-methoxy-1-naphthol and 4-ethoxy-1-naphthol, and benzene compounds such as 1,4-dihydroxybenzene, 1,4-dimethoxybenzene, 1,4-diethoxybenzene, 1-methoxy-4-phenol and 1-ethoxy-4-phenol.

The content of the sensitizing aid is appropriately selected according to the purpose, but is preferably at least 0.1 parts by mass and not more than 10 parts by mass, and more preferably at least 0.5 parts by mass and not more than 5 parts by mass with respect to 1 part by mass of the sensitizer.

Cationic Polymerization Inhibitor

A cationic polymerization inhibitor may be added to the curable liquid developer.

Examples of the cationic polymerization inhibitor include alkali metal compounds and/or alkaline earth metal compounds or amines.

Examples of the amines include alkanolamines, N,N-dimethylalkylamines, N,N-dimethylalkenylamines, N,N-dimethylalkynylamines and the like.

Specific examples thereof include triethanolamine, triisopropanolamine, tributanolamine, N-ethyldiethanolamine, propanolamine, n-butylamine, sec-butylamine, 2-aminoethanol, 2-methylaminoethanol, 3-methylamino-1-propanol, 3-methylamino-1,2-propanediol, 2-ethylaminoethanol, 4-ethylamino-1-butanol, 4-(n-butylamino)-1-butanol, 2-(t-butylamino)ethanol, N,N-dimethylundecanolamine, N,N-dimethyldodecanolamine, N,N-dimethyltridecanolamine, N,N-dimethyltetradecanolamine, N,N-dimethylpentadecanolamine, N,N-dimethylnonadecylamine, N,N-dimethylicosylamine, N,N-dimethyleicosylamine, N,N-dimethylheneicosylamine, N,N-dimethyldocosylamine, N,N-dimethyltricosylamine, N,N-dimethyltetracosylamine, N,N-dimethylpentacosylamine, N,N-dimethylpentanolamine, N,N-dimethylhexanolamine, N,N-dimethylheptanolamine, N,N-dimethyloctanolamine, N,N-dimethylnonanolamine, N,N-dimethyldecanolamine, N,N-dimethylnonylamine, N,N-dimethyldecylamine, N,N-dimethylundecylamine, N,N-dimethyldodecylamine, N,N-dimethyltridecylamine, N,N-dimethyltetradecylamine, N,N-dimethylpentadecylamine, N,N-dimethylhexadecylamine, N,N-dimethylheptadecylamine, and N,N-dimethyloctadecylamine. Besides these, quaternary ammonium salts and the like can also be used. In particular, the cationic polymerization inhibitor is preferably a secondary amine.

The amount of the cationic polymerization inhibitor is preferably at least 1 ppm and not more than 5000 ppm, on a mass basis, in the curable liquid developer.

Radical Polymerization Inhibitor

A radical polymerization inhibitor may be added to the curable liquid developer.

For example, in a curable liquid developer including a vinyl ether compound, the polymerization initiator may be slightly decomposed and converted into a radical compound with the passage of time during storage, and this radical compound may cause polymerization. The radical polymerization inhibitor may be added to prevent such polymerization.

Examples of suitable radical polymerization inhibitors include phenolic hydroxyl group-containing compounds, quinones such as methoquinone (hydroquinone monomethyl ether), hydroquinone, 4-methoxy-1-naphthol and the like, hindered amine antioxidants, 1,1-diphenyl-2-picrylhydrazyl free radical, N-oxyl free radical compounds, nitrogen-containing heterocyclic mercapto compounds, thioether type antioxidants, hindered phenolic antioxidants, ascorbic acids, zinc sulfate, thiocyanates, thiourea derivatives, various saccharides, phosphoric acid antioxidants, nitrites, sulfites, thiosulfates, hydroxylamine derivatives, aromatic amines, phenylenediamines, imines, sulfonamides, urea derivatives, oximes, polycondensates of dicyandiamide and polyalkylenepolyamines, sulfur-containing compounds such as phenothiazine, complexing agents based on tetra-aza-annulene (TAA), hindered amines and the like.

From the viewpoint of preventing the curable liquid developer from thickening, it is preferable to use phenolic hydroxyl group-containing compounds, N-oxyl free radical compounds, a 1,1-diphenyl-2-picrylhydrazyl free radical, phenothiazine, quinones, and hindered amines. More preferred are N-oxyl free radical compounds.

The amount of the radical polymerization inhibitor is preferably at least 1 ppm and not more than 5000 ppm, on a mass basis, in the curable liquid developer.

Other Additives

In addition to the above-described components, the curable liquid developer may include, if necessary, various well-known additives for the purpose of improving recording medium compatibility, storage stability, image storability, and other various properties. For example, a surfactant, a lubricant, a filler, an antifoaming agent, an ultraviolet absorber, an antioxidant, an anti-fading agent, an antifungal agent, a rust preventive agent and the like can be appropriately selected and used.

Hereinafter, the method for producing the curable liquid developer of the present invention will be described in detail.

Method for Producing Curable Liquid Developer

The method of the present invention for producing a curable liquid developer including a toner particle including a colorant and a binder resin, a dispersant, and an insulating liquid (a) which does not dissolve the binder resin comprises:

a step (1) of preparing a liquid mixture including the colorant, the binder resin, the insulating liquid (a) which does not dissolve the binder resin, a solvent (b) which dissolves the binder resin, and the dispersant which is soluble in both the insulating liquid (a) and the solvent (b); and

a step (2) of distilling off the solvent (b) from the liquid mixture, wherein

the insulating liquid (a) includes a monomer having a polymerizable functional group;

a molar average number of functional groups in the insulating liquid (a) is at least 1.8;

a molar average SP value of the insulating liquid (a) is not more than 9.0; and

an average molecular weight of the insulating liquid (a) is at least 250.

Hereinafter, a specific production method will be described, but the present invention is not limited thereto.

### Step (1)

In the step (1), it is preferable to prepare a solution or dispersion by dissolving or dispersing the colorant, the binder resin and the dispersant in the solvent (b) that dissolves the binder resin.

The step of preparing the solution or dispersion may include the following steps.

A step (1-1) of obtaining a first solution or dispersion by mixing the solvent (b), the colorant and, if necessary, the pigment dispersant and dissolving or dispersing the materials with a media type dispersing machine such as an attritor, a ball mill, and a sand mill, or a non-media type dispersing machine such as a high-speed mixer and a high-speed homogenizer.

A step (1-2) of obtaining a second solution or dispersion by adding the binder resin, the dispersant, and the solvent (b) to the first solution or dispersion and dissolving or dispersing the materials with a media type dispersing machine such as an attritor, a ball mill, and a sand mill, or a non-media type dispersing machine such as a high-speed mixer and a high-speed homogenizer.

The amount (total amount) of the solvent (b) added to the binder resin is preferably at least 5 parts by mass and not more than 1000 parts by mass, and more preferably at least 10 parts by mass and not more than 500 parts by mass with respect to 100 parts by mass of the binder resin. When the addition amount of the solvent (b) is within the above range, productivity is satisfactory and a desired toner particle shape is easily formed.

The amount of the binder resin added to the colorant is preferably at least 10 parts by mass and not more than 2000 parts by mass, and more preferably at least 100 parts by mass and not more than 500 parts by mass with respect to 100 parts by mass of the colorant. When the addition amount of the colorant is within the above range, formation of a high-density image is facilitated and a desired toner particle shape is easily formed.

It is preferred that the second solution or dispersion obtained in the step (1-2) and the insulating liquid (a) be then mixed to obtain a liquid mixture in which the binder resin contained in a dissolved state in the second solution or dispersion has precipitated (hereinafter also referred to as a mixing step). In this case, it is preferable that the insulating liquid (a) be added to the second solution or dispersion.

As described above, it is preferable that the binder resin be precipitated (that is, separation into two-phases be performed) during the mixing step. Therefore, it is preferable to mix the insulating liquid (a) in such an amount that the binder resin undergoes two-phase separation in the mixing step.

The two-phase separation of the binder resin means that the binder resin contained in a dissolved state in the second solution or dispersion is precipitated and a state is assumed in which the formation of particles of the binder resin can be confirmed.

In the mixing step, it is preferable to apply a high shearing force when mixing the insulating liquid (a). The shearing force may be appropriately set according to a desired particle diameter. A non-media type dispersing machine such as a high-speed mixer and a high-speed homogenizer is preferable as a high-speed shearing device capable of imparting a high shearing force.

Further, there are various types of such dispersing machines that differ in capacity, rotational speed, model, and the like, and an appropriate dispersing machine may be used according to the production mode. The rotation speed when a homogenizer is used is preferably at least 500 rpm and not more than 30,000 rpm, and more preferably at least 13,000 rpm and not more than 28,000 rpm.

The mixing step is preferably carried out at a temperature which is at least the solidification point and not more than the boiling point of the solvent (b) and the insulating liquid (a). Specifically, the mixing step is preferably carried out at at least 0° C. and not more than 60° C.

When the mixing mass ratio is in the above range, since the solid fraction concentration after the solvent (b) has been distilled off is appropriate, the dispersion stability of the toner particles is likely to be further improved, and the film thickness at the time of development can be reduced.

### Step (2)

The step (2) is a step of distilling off the solvent (b) that dissolves the binder resin from the mixed liquid obtained in the step (1).

Evaporation or the like is suitable as a method for distilling off the solvent (b). As for conditions, the distillation is preferably carried out at a pressure of 1 kPa to 200 kPa (reduced pressure state) at 0° C. to 60° C.

Step of Preparing Curable Liquid Developer

After the step (2), a step of preparing a curable liquid developer may be included. In the step of preparing the curable liquid developer, a charge control agent, other additives and the like are added, if necessary, to the toner particle dispersion obtained in the step (2) to prepare the curable liquid developer. The method of adding the charge control agent and other additives is not particularly limited, but appropriate heating and stirring can be performed depending on the kind of additives.

Further, in this step, it is also possible to appropriately add unit operations such as washing toner particles.

Toner Particle

According to the present invention, it is possible to produce a curable liquid developer having a small particle diameter of the toner particle and a satisfactory curing rate during image formation.

From the viewpoint of obtaining a high-definition image, the volume-based 50% particle diameter (D50) of the toner particles is preferably at least 0.05 μm and not more than 5.0 μm, more preferably at least 0.05 μm and not more than 1.2 μm, and even more preferably at least 0.05 μm and not more than 1.0 μm.

When the volume-based 50% particle diameter (D50) of the toner particles is within the above ranges, the resolution and image density of the toner image formed by the curable liquid developer can be made sufficiently high. Further, even in the recording system in which the insulating liquid (a) remains on the recording medium, the film thickness of the toner image can be made sufficiently small.

In this specification, the “average particle diameter” means the volume-based average particle diameter.

The toner particle concentration in the curable liquid developer can be arbitrarily adjusted according to the image forming apparatus to be used, and the toner particle concentration may be set to at least about 1% by mass and not more than about 70% by mass.

Image Forming Apparatus

The curable liquid developer can be suitably used in a general image forming apparatus of an electrophotographic system.

### EXAMPLES

Hereinafter, the present invention will be described in detail with reference to Examples, but the present invention is not limited to these Examples. Unless otherwise specified, “parts” and “%” mean “parts by mass” and “% by mass”, respectively.

Measurement Methods

Measurement methods used in the synthesis examples in the Examples of the present invention are describes below.

(1) Method for Measuring Molecular Weight [Weight Average Molecular Weight (Mw) and Number Average Molecular Weight (Mn)]

Molecular weights of resins and the like were calculated in terms of polystyrene by using gel permeation chromatography (GPC). Measurement of molecular weight by GPC was carried out in the following manner.

A sample was added to the following eluent so that the sample concentration became 1.0% by mass, and the eluent was allowed to stand at room temperature for 24 h to dissolve the sample. The solution was filtered through a solvent-resistant membrane filter having a pore diameter of 0.20 μm to obtain a sample solution. Measurements were performed under the following conditions.

Apparatus: High-speed GPC apparatus “HLC-8220 GPC”
(manufactured by Tosoh Corporation)
Column: two columns of LF-804 series
Eluent: tetrahydrofuran (THF)
Flow rate: 1.0 mL/min
Oven temperature: 40° C.
Sample injection amount: 0.025 mL

Molecular weight calibration curves prepared with standard polystyrene resins (TSK Standard Polystyrenes F-850, F-450, F-288, F-128, F-80, F-40, F-20, F-10, F-4, F-2, F-1, A-5000, A-2500, A-1000, A-500, manufactured by Tosoh Corporation) were used to calculate the molecular weight of the sample.

(2) Method for Measuring Acid Value

The acid value of the binder resin was determined by the following method.

Basic operations are based on JIS K-0070.

1) A total of 0.5 g to 2.0 g of the sample is accurately weighed. The mass at this time is taken as M1 (g).

2) The sample is placed in a 50 mL beaker and dissolved by adding 25 mL of a liquid mixture of tetrahydrofuran/ethanol (2/1).

3) Titration is carried out using a 0.1 mol/L KOH ethanol solution and a potentiometric titration measuring apparatus (for example, an automatic titration measuring apparatus “COM-2500” manufactured by Hiranuma Sangyo Co., Ltd. can be used).

4) The amount of the KOH solution used at this time is taken as A (mL). A blank is measured at the same time, and the amount of KOH used at this time is taken as B (mL).

5) The acid value is calculated by the following formula (i). Here, f is a factor of the KOH solution.

$$Acid value [ mgKOH \text{/} g ] = \frac{[ ( A - B ) \times f \times 5.61 ]}{M 1} \qquad ( i )$$

(3) Method for Measuring the Hydroxyl Value

The hydroxyl value of the binder resin was determined by the following method.

Basic operations are based on JIS K 0070-1992.

1) A total of 25 g of special grade acetic anhydride is placed in a 100 mL measuring flask and pyridine is added to make the total volume 100 mL, followed by sufficient shaking to obtain an acetylation reagent. The obtained acetylation reagent is stored in a brown bottle to prevent contact with moisture, carbon dioxide, etc.

2) A total of 0.5 g to 2.0 g of the sample is accurately weighed. The mass at this time is taken as M2 (g).

3) The sample is placed in a 50 mL beaker and dissolved by adding 25 mL of a liquid mixture of tetrahydrofuran/ethanol (2/1).

4) A total of 5.0 mL of the acetylation reagent is accurately added to the solution by using a whole pipette. A small funnel is placed in the mouth of the flask and heating is performed in a glycerin bath at about 97° C., with about 1 cm of the bottom of the flask being immersed in the bath. At this time, in order to prevent the temperature of the neck of the flask from rising due to the heat of the bath, it is preferable to cover the neck of the flask with cardboard with a round hole.

5) After 1 hour, the flask is removed from the glycerin bath and allowed to cool. After cooling down, 1 mL of water is added from the funnel and the flask is shaken to hydrolyze acetic anhydride. For even more complete hydrolysis, the flask is again heated in a glycerin bath for 10 min.

6) Titration is carried out using a 0.1 mol/L KOH ethanol solution and a potentiometric titration measuring apparatus (for example, an automatic titration measuring apparatus “COM-2500” manufactured by Hiranuma Sangyo Co., Ltd. can be used). The titration amount at this time is taken as C (mL). A blank is measured at the same time, and the amount of KOH used at this time is taken as D (mL).

7) The obtained results are substituted into the following formula (ii) to calculate the hydroxyl value.

$$Hydroxyl value [ mg KOH \text{/} g ] = \frac{[ ( D - C ) \times 28.05 \times f ]}{M 2} + Acid value [ mgKOH \text{/} g ] \qquad ( ii )$$

### Example 1

### Synthesis Example of Binder Resin (PES-101)

The following PES-101 was synthesized by a known method.

Composition (molar ratio): terephthalic acid/trimellitic acid/ethylene oxide 2 mol adduct of bisphenol A=37.5/12.5/50

### Mw=18,300, Mn=2420

Acid value: 20.5 mg KOH/g, hydroxyl value: 50.3 mg KOH/g

### Synthesis Example of Binder Resin (PES-102)

The following PES-102 was synthesized by a known method.

Composition (molar ratio): terephthalic acid/isophthalic acid/trimellitic acid/ethylene glycol/neopentyl glycol=49.5/49.5/1/60/40

### Mw=20,000, Mn=4900

Acid value: 15.1 mg KOH/g, hydroxyl value: 7.8 mg KOH/g

### Example 2

### Synthesis Example of Compound (22)

1,12-Octadecanediol (6.73 g, 24.7 mmol) indicated as a starting material 1 and vinyl acetate (16 g, 186 mmol) were added to a liquid mixture of di-μ-chlorobis(1,5-cyclooctadiene) diiridium (I) [Ir(cod)Cl]₂ (0.15 mg, 0.2 mmol) and potassium carbonate (13.5 g, 98 mmol) in toluene (40.0 ml) and stirring was performed for 6 h at 100° C. under an argon atmosphere.

Analysis of the reaction liquid by gas chromatography revealed that the conversion ratio of the starting material 1 was 93%, and a bifunctional vinyl ether monomer represented by Compound (22) was produced at a yield of 55%. The organic phase and the aqueous phase were separated using a fractionation funnel and the organic phase was purified by column chromatography, concentrated under reduced pressure and dried to give Compound (22) (molecular weight: 338.6). The obtained compound was a slightly brown transparent viscous liquid. The FT-IR measurement of Compound (22) confirmed that the peak derived from the hydroxyl group disappeared.

### Example 3

### Preparation Examples of Insulating Liquids (a-1) to (a-14)

Insulating liquids (a-1) to (a-14) having the compositions shown in Table 1 were placed in a mayonnaise bottle and stirred overnight with a mix rotor.

TABLE 1

| | | | | Physical properties | | |
|---|---|---|---|---|---|---|
| | Composition | | | Molar average | | |
| | Monomer having | | Amount of | number of | Molar | Average |
| Insulating | polymerizable | Hydrophobic | monomer | functional | average SP | molecular |
| liquid No. | functional group | compound | [%] | groups | value | weight |
| a-1 | Compound (22) | — | 100 | 2.0 | 8.3 | 338 |
| a-2 | Compound (11) | BI2000 | 97 | 2.0 | 8.3 | 306 |
| a-3 | Compound (12) | BI2000 | 97 | 2.0 | 8.4 | 306 |
| a-4 | Compound (11) | — | 100 | 2.0 | 8.3 | 254 |
| a-5 | Compound (12) | — | 100 | 2.0 | 8.4 | 254 |
| a-6 | Compound (10) | BI2000 | 90 | 2.0 | 8.3 | 391 |
| a-7 | Compound (4) | BI2000 | 90 | 3.0 | 8.6 | 391 |
| a-8 | Compound (4) | BI2000 | 60 | 2.8 | 8.6 | 927 |
| a-9 | Compound (4) | BI2000 | 50 | 2.7 | 8.6 | 1106 |
| a-10 | Compound (7) | BI2000 | 90 | 2.0 | 8.1 | 391 |
| a-11 | Compound (7) | BI2000 | 60 | 1.9 | 8.1 | 927 |
| a-12 | Compound (7) | BI2000 | 50 | 1.8 | 8.1 | 1106 |
| a-13 | Compound (7) | BI3000 | 95 | 2.0 | 8.1 | 351 |
| a-14 | OXT-221 | BI2000 | 95 | 2.0 | 8.8 | 303 |

In Table 1, Compounds (4), (7), (10), (11), (12), and (22) represent exemplary compounds in the present description. BI 2000 and BI 3000 mean hydrogenated polybutadienes BI-2000 and BI-3000 manufactured by Nippon Soda Co., Ltd. OXT-221 means ARON OXETANE OXT-221 manufactured by Toagosei Co., Ltd.

The “Amount of monomer” in the table indicates the amount (% by mass) of the polymerizable monomer in the insulating liquid.

### Comparative Example 1

### Preparation Examples of Comparative Insulating Liquids (a-101) to (a-103)

Insulating liquids (a-101) to (a-103) having the compositions shown in Table 2 were placed in a mayonnaise bottle and stirred overnight with a mix rotor.

TABLE 2

| | | | | Physical properties | | |
|---|---|---|---|---|---|---|
| | Composition | | | Molar average | | |
| | Monomer having | | Amount of | number of | Molar | Average |
| Insulating | polymerizable | Hydrophobic | monomer | functional | average SP | molecular |
| liquid | functional group | compound | [%] | groups | value | weight |
| a-101 | Compound (7) | BI2000 | 40 | 1.7 | 8.1 | 1285 |
| a-102 | Compound (1)/ | — | 100 | 2.0 | 9.0 | 191 |
| | Compound (4)/ | | | | | |
| | Compound (104) = | | | | | |
| | 10/50/40 | | | | | |
| a-103 | Compound (1)/ | — | 100 | 1.7 | 8.3 | 211 |
| | Compound (4)/ | | | | | |
| | Compound (101) = | | | | | |
| | 10/30/60 | | | | | |

In the table, Compounds (1), (4), (7), (101) and (104) represent exemplary compounds in the present description. The mixing ratios of these compounds are on a mass basis.

### Example 4

### Production Steps of Curable Liquid Developer

### Production Example of Pigment Dispersion (Cy-1)

### Production Step of Pigment Dispersion

Pigment Blue 15:3 (30 parts), VYLON UR 4800 (manufactured by Toyobo Co., Ltd., resin concentration 32%) (47 parts), tetrahydrofuran (255 parts), glass beads (diameter 1 mm) (130 parts) were mixed, dispersed for 3 h with an attritor (manufactured by Nippon Coke & Engineering Co., Ltd.), and filtered through a mesh to obtain a kneaded material.

A total of 180 parts of the obtained kneaded material, 126 parts of a 50% tetrahydrofuran solution of a polyester (PES-101), and 21 parts of a toner particle dispersant (AJISPER PB-817, manufactured by Ajinomoto Fine-Techno Co., Inc.) were mixed with a high-speed disperser (T.K. ROBOMIX/T.K. HOMODISPER, Model 2.5, blade, manufactured by Primix Corporation), and mixed while stirring at 40° C. to obtain a pigment dispersion (Cy-1).

### Production Example of Pigment Dispersion (Cy-2)

A pigment dispersion (Cy-2) was prepared in the same manner as in the production example of the pigment dispersion (Cy-1), except that the 50% tetrahydrofuran solution of the polyester (PES-101) was changed to a 50% tetrahydrofuran solution of a polyester (PES-102) in the production example of the pigment dispersion (Cy-1).

### Production Examples of Pigment Dispersions (M-1), (Y-1) and (Bk-1)

Pigment dispersions (M-1), (Y-1) and (Bk-1) were prepared by the same method as in the production example of the pigment dispersion (Cy-1), except that Pigment Blue 15:3 was changed to Pigment Red 122, Pigment Yellow 155, and carbon black, respectively, in the production example of the pigment dispersion (Cy-1).

Mixing Step

### Production Example of Liquid Mixture (D-1)

A total of 22 parts of the insulating liquid (a-1) shown in Table 1 was added little by little to 34 parts of the obtained pigment dispersion liquid (Cy-1), while stirring at a high speed (rotation speed 25,000 rpm) by using a homogenizer (ULTRA TURRAX T50 manufactured by IKA Corporation), to obtain a mixed solution (D-1).

### Distillation Step

The obtained liquid mixture (D-1) was transferred to a pear-shaped flask, and tetrahydrofuran was completely distilled off at 50° C. under ultrasonic dispersion to obtain a toner particle dispersion (T-1) containing toner particles in the insulating liquid.

Preparation Step of Curable Liquid Developer Production Example of Curable Liquid Developer (LD-1)

A total of 100 parts of the obtained toner particle dispersion (T-1) was centrifuged, the supernatant was removed by decantation and replaced with a new insulating liquid (a-1) having the same mass as the removed supernatant, and redispersed. Then, 0.10 part of LECINOL S-10 (hydrogenated lecithin, manufactured by Nikko Chemicals Co., Ltd.), 0.21 part of the photopolymerization initiator represented by the formula (A-26) above as a polymerization initiator, and 0.35 part of KAYACURE-DETX-S (manufactured by Nippon Kayaku Co., Ltd.) were added to obtain a curable liquid developer (LD-1).

### Production Example of Curable Liquid Developers (LD-2) to (LD-18)

Curable liquid developers (LD-2) to (LD-18) were obtained by a method similar to the production example of the curable liquid developer (LD-1), except that the pigment dispersion and the insulating liquid were changed according to Table 3 in the production example of the curable liquid developer (LD-1).

TABLE 3

| | Pigment | | | |
|---|---|---|---|---|
| Liquid | dispersion | Insulating | Liquid mixture | Toner particle |
| developer No. | No. | liquid No. | No. | dispersion No. |
| LD-1 | Cy-1 | a-1 | D-1 | T-1 |
| LD-2 | Cy-1 | a-2 | D-2 | T-2 |
| LD-3 | Cy-1 | a-3 | D-3 | T-3 |
| LD-4 | Cy-1 | a-4 | D-4 | T-4 |
| LD-5 | Cy-1 | a-5 | D-5 | T-5 |
| LD-6 | Cy-1 | a-6 | D-6 | T-6 |
| LD-7 | Cy-1 | a-7 | D-7 | T-7 |
| LD-8 | Cy-1 | a-8 | D-8 | T-8 |
| LD-9 | Cy-1 | a-9 | D-9 | T-9 |
| LD-10 | Cy-1 | a-10 | D-10 | T-10 |
| LD-11 | Cy-1 | a-11 | D-11 | T-11 |
| LD-12 | Cy-1 | a-12 | D-12 | T-12 |
| LD-13 | Cy-1 | a-13 | D-13 | T-13 |
| LD-14 | Cy-1 | a-14 | D-14 | T-14 |
| LD-15 | M-1 | a-1 | D-15 | T-15 |
| LD-16 | Y-1 | a-1 | D-16 | T-16 |
| LD-17 | Bk-1 | a-1 | D-17 | T-17 |
| LD-18 | Cy-2 | a-1 | D-18 | T-18 |

### Comparative Example 2

### Production Step of Comparative Curable Liquid Developer

### Production Examples of Comparative Curing Liquid Developers (LD-101) to (LD-103)

Curable liquid developers (LD-101) to (LD-103) were obtained by a method similar to the production example of the curable liquid developer (LD-1), except that the pigment dispersion and the insulating liquid were changed according to Table 4 in the production example of the curable liquid developer (LD-1).

TABLE 4

| | Pigment | | | |
|---|---|---|---|---|
| Liquid | dispersion | Insulating | Liquid | Toner particle |
| developer No. | No. | liquid No. | mixture No. | dispersion No. |
| LD-101 | Cy-1 | a-101 | D-101 | T-101 |
| LD-102 | Cy-1 | a-102 | D-102 | T-102 |
| LD-103 | Cy-1 | a-103 | D-103 | T-103 |

### Example 5

The curable liquid developers (LD-1) to (LD-18) were evaluated by the following method.

Measurement of Toner Particle Diameter

The particle diameter of the toner particles in the curable liquid developer was measured using a laser diffraction/scattering type particle diameter distribution measuring apparatus (trade name “LA-950”, manufactured by Horiba, Ltd). The particle diameter was evaluated by a volume-based 50% particle diameter (D50).

Evaluation criteria for the particle diameter are shown below. In this evaluation, 3 and more were determined as satisfactory.

### 5: (D50)≤1.0 μm

4: 1.0 μm<(D50)≤1.2 μm
3: 1.2 μm<(D50)≤1.5 μm
2: 1.5 μm<(D50)≤2.0 μm
1: 2.0 μm<(D50)

The evaluation results are shown in Table 5.

Measurement of Fixability

In an environment of room temperature 25° C. and humidity 50%, a curable liquid developer was dropped onto a polyethylene terephthalate film (PANLITE: PC-2151, thickness 0.3 mm, manufactured by Teijin Kasei Co., Ltd.), bar-coated (thickness of the formed film was 8.0 μm) using a wire bar (No. 6) (supplier: Matsuo Sangyo Co., Ltd.), and irradiated with light with a wavelength of 365 nm by using a high-pressure mercury lamp with a lamp output of 120 mW/cm² with respect to the irradiation light quantity of the following 5 types to form cured films. The irradiation light quantity when the surface was not tacky (adhesive) and was completely cured was measured, and the evaluation was made according to the following criteria.

5: at 100 mJ/cm² (cured)
4: at 200 mJ/cm² (cured)
3: at 400 mJ/cm² (cured)
2: at 1000 mJ/cm² (cured)
1: at 2000 mJ/cm² (cured or not cured)

The evaluation results are shown in Table 3.

Measurement of Developing Performance

Development was carried out by the following method by using the curable liquid developers obtained in the present invention. An apparatus such as shown in the FIGURE was used.

(1) A developing roller 53C, a photosensitive drum 52C, and an intermediate transfer roller 61C in an image forming apparatus 50C were separated and rotated in a contactless state in the direction of the arrow in the FIGURE. The rotation speed at this time was 250 mm/sec.

(2) The developing roller 53C and the photosensitive drum 52C were brought into contact at a constant pressing pressure, and a bias was set using the aforementioned DC power source. The development bias was 200 V.

(3) The photosensitive drum 52C and the intermediate transfer roller 61C were brought into contact at a constant pressing pressure, and a bias was set using the DC power supply. The transfer bias was 1000 V.

(4) A developing solution of a uniform concentration (2%) and a uniform amount (100 ml) was supplied onto a film forming roller, and the image on the intermediate transfer member 60C was evaluated.

The evaluation criteria of developing performance are shown below. In this evaluation, 3 or more were determined as satisfactory.

5: High-density and high-definition image was obtained;
4: There is some density unevenness, or some image blur is observed;
3: Although density unevenness and image blur are conspicuous, it is clear that the development has been performed;
2: Significant density unevenness and image blur occurred, and development was insufficient;
1: Development was impossible.

The evaluation results are shown in Table 5.

### Comparative Example 3

The toner particle diameter, fixability and developing performance were evaluated with respect to the comparative curable liquid developers (LD-101) to (LD-103) in the same manner as in Example 5.

The evaluation results are shown in Table 5.

TABLE 5

| | Insulating liquid | | | | | | |
|---|---|---|---|---|---|---|---|
| | | Physical properties | | | | | |
| | | Molar average | | | | | |
| Liquid | | number of | Molar | Average | Evaluation results | | |
| developer | | functional | average | molecular | Particle | | Developing |
| No. | No. | groups | SP value | weight | diameter | Fixability | performance |
| LD-1 | a-1 | 2.0 | 8.3 | 338 | 5 | 5 | 5 |
| LD-2 | a-2 | 2.0 | 8.3 | 306 | 5 | 5 | 5 |
| LD-3 | a-3 | 2.0 | 8.4 | 306 | 4 | 5 | 5 |
| LD-4 | a-4 | 2.0 | 8.3 | 254 | 5 | 5 | 5 |
| LD-5 | a-5 | 2.0 | 8.4 | 254 | 4 | 5 | 5 |
| LD-6 | a-6 | 2.0 | 8.3 | 391 | 3 | 5 | 5 |
| LD-7 | a-7 | 3.0 | 8.6 | 391 | 3 | 4 | 5 |
| LD-8 | a-8 | 2.8 | 8.6 | 927 | 3 | 4 | 4 |
| LD-9 | a-9 | 2.7 | 8.6 | 1106 | 3 | 4 | 3 |
| LD-10 | a-10 | 2.0 | 8.1 | 391 | 4 | 4 | 5 |
| LD-11 | a-11 | 1.9 | 8.1 | 927 | 3 | 4 | 4 |
| LD-12 | a-12 | 1.8 | 8.1 | 1106 | 3 | 3 | 3 |
| LD-13 | a-13 | 2.0 | 8.1 | 351 | 4 | 4 | 5 |
| LD-14 | a-14 | 2.0 | 8.8 | 303 | 3 | 3 | 3 |
| LD-15 | a-1 | 2.0 | 8.3 | 338 | 5 | 5 | 5 |
| LD-16 | a-1 | 2.0 | 8.3 | 338 | 5 | 5 | 5 |
| LD-17 | a-1 | 2.0 | 8.3 | 338 | 5 | 5 | 5 |
| LD-18 | a-1 | 2.0 | 8.3 | 338 | 5 | 5 | 5 |
| LD-101 | a-101 | 1.7 | 8.1 | 1285 | 3 | 1 | 3 |
| LD-102 | a-102 | 2.0 | 9.0 | 191 | 1 | 4 | 2 |
| LD-103 | a-103 | 1.7 | 8.3 | 211 | 3 | 1 | 2 |

The present invention can provide a method for producing a curable liquid developer in which the particle diameter of toner particle in the curable liquid developer is small and the curing rate during image formation is satisfactory. An inkjet ink, a liquid developer for wet electrophotography, and an electrostatic inkjet ink which have higher sensitivity, low viscosity, excellent storage stability, high safety, high optical density, and sufficient fixability and hardly cause image blur can be expected to be obtained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-228260, filed Nov. 24, 2016, and Japanese Patent Application No. 2017-196694, filed Oct. 10, 2017, which are hereby incorporated by reference herein in their entirety.

What is claimed is:

1. A method for producing a curable liquid developer including a toner particle including a colorant and a binder resin, a dispersant, and an insulating liquid (a) which does not dissolve the binder resin, the method comprising:
a step (1) of preparing a liquid mixture including the colorant, the binder resin, the insulating liquid (a) which does not dissolve the binder resin, a solvent (b) which dissolves the binder resin, and the dispersant which is soluble in both the insulating liquid (a) and the solvent (b); and
a step (2) of distilling off the solvent (b) from the liquid mixture, wherein
the insulating liquid (a) includes a monomer having a polymerizable functional group;
a molar average number of functional groups in the insulating liquid (a) is at least 1.8;
a molar average SP value of the insulating liquid (a) is not more than 9.0; and
an average molecular weight of the insulating liquid (a) is at least 250.

2. The method for producing a curable liquid developer according to claim 1, wherein an amount of the monomer having a polymerizable functional group in the insulating liquid (a) is at least 60% by mass with respect to a total mass of the insulating liquid (a).

3. The method for producing a curable liquid developer according to claim 2, wherein an amount of the monomer having a polymerizable functional group in the insulating liquid (a) is at least 90% by mass with respect to a total mass of the insulating liquid (a).

4. The method for producing a curable liquid developer according to claim 1, wherein the monomer having a polymerizable functional group is a compound represented by a general formula (1):
(R1-CH═CH—O—)ₙR2 Formula (1)
(In the formula (1), n represents an integer of at least 2, R1 represents a hydrogen atom or an alkyl group having at least 1 and not more than 3 carbon atoms, and R2 represents a n-valent group obtained by removing n hydrogen atoms from an aliphatic hydrocarbon.)

5. The method for producing a curable liquid developer according to claim 1, wherein the monomer having a polymerizable functional group is a compound represented by a general formula (2):
(R1-CH═CH—O—)ₙCₘH₍₂ₘ₊₂₋ₙ₎ Formula (2)
(In the formula (2), m represents an integer of at least 12 and not more than 50, n represents an integer of at least 2, and R1 represents a hydrogen atom or an alkyl group having at least 1 and not more than 3 carbon atoms.)

6. The method for producing a curable liquid developer according to claim 5, wherein at least one of vinyl ether groups represented by the general formula (2A) in the general formula (2) is bonded to a carbon atom other than an end atom among carbon atoms constituting a partial structure represented by the general formula (2B) in the general formula (2):
(R1-CH═CH—O—)ₙ Formula (2A)
CₘH₍₂ₘ₊₂₋ₙ₎ Formula (2B)
(In the formulas (2A) and (2B), m, n and R1 have the same meanings as m, n and R1 in the formula (2).]
